(19) United States
(12) Patent Application Publication
(10) Pub. No.: US 2023/0041109 A1
(43) Pub. Date: Feb. 9, 2023

(54) METHOD AND APPARATUS FOR UPLINK TRANSMISSION

(71) Applicant: Lenovo (Beijing) Ltd., Beijing (CN)

(72) Inventors: Wei Ling, Changping District (CN); Chenxi Zhu, Haidian District (CN); Bingchao Liu, Changping District (CN); Yi Zhang, Chaoyang District (CN)

(73) Assignee: Lenovo (Beijing) Ltd., Beijing (CN)

(21) Appl. No.: 17/789,957

(22) PCT Filed: Jan. 17, 2020
(86) PCT No.: PCT/CN2020/072650

§ 371 Date: Jun. 29, 2022

(51) Int. Cl. H04W 72/12; H04W 16/28; H04L 5/00

(52) U.S. Cl. CPC H04W 72/1268; H04W 72/1289; H04W 16/28; H04L 5/0051

(57) ABSTRACT

The present disclosure relates to methods and apparatuses. According to some embodiments of the disclosure, a method includes: receiving Downlink Control Information (DCI) in a first Control Resource Set (CORESET), wherein the DCI schedules a Physical Uplink Shared Channel (PUSCH) and the first CORESET is configured with a first pool index; and transmitting the PUSCH scheduled by the DCI according to a pathloss reference Reference Signal (RS) based on the first pool index.

### TECHNICAL FIELD

Embodiments of the present disclosure generally relate to wireless communication technology, especially to uplink transmission in a wireless communication system.

### BACKGROUND

A Control Resource Set (CORESET) is a time-frequency resource where a User Equipment (UE) attempts to decode a downlink control channel in one or more search spaces. For example, a UE may decode a Physical Downlink Control Channel (PDCCH) in one or more search spaces associated with a CORESET. The PDCCH may carry Downlink Control Information (DCI), which may schedule uplink channels, such as a Physical Uplink Shared Channel (PUSCH), or downlink channels, such as a Physical Downlink Shared Channel (PDSCH).

In some wireless communication systems, such as 3rd Generation Partnership Project (3GPP) New Radio (NR) systems, a UE may be configured with uplink power control parameters (e.g., pathloss references). There is a need for handling the power control of uplink transmissions, such as PUSCH transmissions, in these wireless communication systems.

Moreover, in some wireless communication systems, such as 3GPP NR systems, a UE may be configured with multiple downlink beams (e.g., TCI (Transmission Configuration Indicator) states) and multiple uplink beams, such as spatial relation information, for downlink reception and uplink transmission, respectively. There is a need for handling the beam management/control of uplink transmissions, such as PUSCH transmissions, in these wireless communication systems.

### SUMMARY

An embodiment of the present disclosure provides a method. The method may include: receiving Downlink Control Information (DCI) in a first Control Resource Set (CORESET), wherein the DCI schedules a Physical Uplink Shared Channel (PUSCH) and the first CORESET is configured with a first pool index; and transmitting the PUSCH scheduled by the DCI according to a pathloss reference RS based on the first pool index. The format of the DCI may be DCI format 0_0. Transmitting the PUSCH scheduled by the DCI may further include transmitting the PUSCH scheduled by the DCI according to spatial relation information based on the first pool index.

In an embodiment of the present application, the pathloss reference RS of the PUSCH may be in a list of PUSCH pathloss reference RSs identified by a predefined index, wherein the predefined index may be associated with the first pool index. Different predefined indexes may be associated with different pool indexes.

In another embodiment of the present disclosure, the pathloss reference RS of the PUSCH may be an RS of Quasi Co-Location (QCL) information of a Transmission Configuration Indicator (TCI) state of a second CORESET having the lowest index among all CORESETs configured with the first pool index when the TCI state of the second CORESET does not indicate a spatial QCL parameter. The QCL information of the TCI state may be the first QCL information in the TCI state.

In another embodiment of the present disclosure, the pathloss reference RS of the PUSCH may be associated with a spatial Quasi Co-Location (QCL) parameter of a Transmission Configuration Indicator (TCI) state of a second CORESET having the lowest index among all CORESETs configured with the first pool index. The spatial relation information may be based on an RS, which may be associated with a spatial QCL parameter of a TCI state of a second CORESET having the lowest index among all CORESETs configured with the first pool index.

In another embodiment of the present disclosure, the pathloss reference RS of the PUSCH may be a pathloss reference RS of a Physical Uplink Control Channel (PUCCH) resource having the lowest resource index among all PUCCH resources associated with the first pool index when at least one PUCCH resource is configured with spatial relation information. The spatial relation information may include spatial relation information of a Physical Uplink Control Channel (PUCCH) resource having the lowest resource index among all PUCCH resources associated with the first pool index when at least one PUCCH resource is configured with spatial relation information.

Another embodiment of the present disclosure provides a method. The method may include receive a Physical Uplink Shared Channel (PUSCH) scheduled by Downlink Control Information (DCI), wherein a pathloss reference RS of the PUSCH may be based on a first pool index configured in a first Control Resource Set (CORESET) for the DCI. The format of the DCI may be DCI format 0_0. The spatial relation information of the PUSCH may be based on the first pool index.

In an embodiment of the present application, the pathloss reference RS of the PUSCH may be in a list of PUSCH pathloss reference RS s identified by a predefined index, wherein the predefined index may be associated with the first pool index. Different predefined indexes may be associated with different pool indexes.

In another embodiment of the present disclosure, the pathloss reference RS of the PUSCH may be an RS of Quasi Co-Location (QCL) information of a Transmission Configuration Indicator (TCI) state of a second CORESET having the lowest index among all CORESETs configured with the first pool index when the TCI state of the second CORESET does not indicate a spatial QCL parameter. The QCL information of the TCI state may be the first QCL information in the TCI state.

In another embodiment of the present disclosure, the pathloss reference RS of the PUSCH may be associated with a spatial Quasi Co-Location (QCL) parameter of a Transmission Configuration Indicator (TCI) state of a second CORESET having the lowest index among all CORESETs configured with the first pool index. The spatial relation information may be based on an RS, which may be associated with a spatial QCL parameter of a TCI state of a second CORESET having the lowest index among all CORESETs configured with the first pool index.

In another embodiment of the present disclosure, the pathloss reference RS of the PUSCH may be a pathloss reference RS of a Physical Uplink Control Channel (PUCCH) resource having the lowest resource index among all PUCCH resources associated with the first pool index when at least one PUCCH resource is configured with spatial relation information. The spatial relation information may be spatial relation information of a Physical Uplink Control Channel (PUCCH) resource having the lowest resource index among all PUCCH resources associated with the first pool index when at least one PUCCH resource is configured with spatial relation information.

Another embodiment of the present disclosure provides an apparatus. The apparatus may include at least one receiver and at least one transmitter. The at least one receiver may receive Downlink Control Information (DCI) in a first Control Resource Set (CORESET), wherein the DCI may schedule a Physical Uplink Shared Channel (PUSCH) and the first CORESET may be configured with a first pool index. The at least one transmitter may transmit the PUSCH scheduled by the DCI according to a pathloss reference RS based on the first pool index.

Another embodiment of the present disclosure provides an apparatus. The apparatus may include at least one receiver. The at least one receiver may receive a Physical Uplink Shared Channel (PUSCH) scheduled by Downlink Control Information (DCI). A pathloss reference RS of the PUSCH may be based on a first pool index configured in a first Control Resource Set (CORESET) for the DCI.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present disclosure;

FIG. 2 illustrates an exemplary procedure of uplink transmission according to some embodiments of the present disclosure.

FIG. 3 illustrates an exemplary procedure of pathloss reference RS determination according to some embodiments of the present disclosure.

FIG. 4 illustrates an exemplary procedure of pathloss reference RS determination according to some embodiments of the present disclosure.

FIG. 5 illustrates an exemplary procedure of pathloss reference RS and spatial relation information determination according to some embodiments of the present disclosure.

FIG. 6 illustrates an exemplary procedure of pathloss reference RS and spatial relation information determination according to some embodiments of the present disclosure.

FIG. 7 illustrates an exemplary procedure of uplink reception according to some embodiments of the present disclosure.

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as 3GPP 5G (NR), 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

A wireless communication system may have one Transmit-Receive Point (TRP) or some TRPs. A TRP may act like a small base station. The TRPs may communicate with each other via backhaul link(s). Such backhaul link may be an ideal backhaul link or a non-ideal backhaul link. Latency of the ideal backhaul link may be deemed as zero, and latency of the non-ideal backhaul link may be larger than that of the ideal backhaul, for example, tens of milliseconds.

In a wireless communication system, one single TRP may be used to serve one or more UEs under control of a base station. A base station may support one or more TRPs. In different application scenarios, the TRP may be described using different terms. In fact, in some application scenarios, for example, in a CoMP (Coordinated Multi-Point) scenario, the TRP can even be a base station. Persons skilled in the art should understand that as 3GPP (3rd Generation Partnership Project) and the communication technology develop, the terminologies recited in the specification may change, which should not affect the scope of the present disclosure.

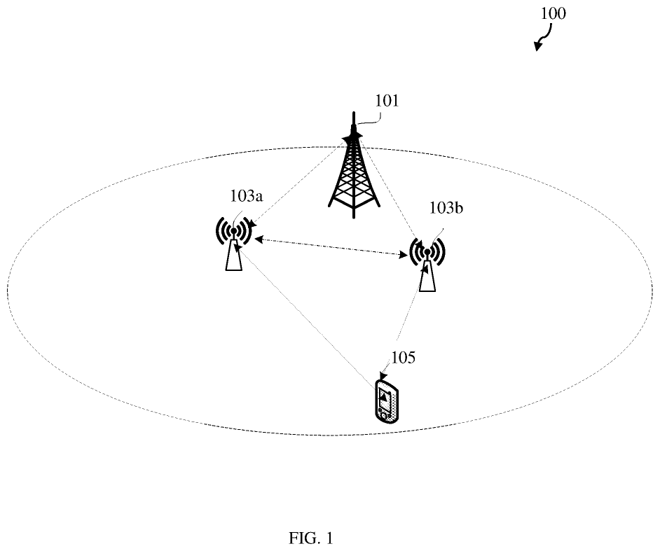

FIG. 1 is a schematic diagram illustrating an exemplary wireless communication system 100 according to some embodiments of the present disclosure.

Referring to FIG. 1, the wireless communication system 100 may include a base station (e.g., base station 101), some TRPs (e.g., TRP 103a and TRP 103b), and a UE (e.g., UE 105). Although only one base station, two TRPs, and one UE are shown for simplicity, it should be noted that the wireless communication system 100 may further include more base stations, TRPs, and UEs.

TRP 103a and TRP 103b may be connected to base station 101, via, for example, a backhaul link. Each of TRP 103a and TRP 103b may serve a number of UEs. As shown in FIG. 1, TRP 103a and TRP 103b can serve UE 105 within a serving area or region (e.g., a cell or a cell sector). TRP 103a and TRP 103b may communicate with each other via, for example, a backhaul link. In some other embodiments of the present disclosure, TRP 103a and TRP 103b may be connected to different base stations.

In some embodiments of the present disclosure, base station 101 may also be referred to as an access point, an access terminal, a base, a macro cell, a Node-B, an evolved Node B (eNB), a gNB, or described using other terminology used in the art. UE 105 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 105 can be a computing device, a wearable device, or a mobile device, etc.

In the present application, it is assumed that TRPs independently schedule UL (uplink) transmission. The communication between these TRPs may be via a non-ideal or ideal backhaul link. For example, referring to FIG. 1, TRP 103a may transmit Downlink Control Information (DCI) to UE 105 to schedule an uplink transmission such as a Physical Uplink Shared Channel (PUSCH), and TRP 103b may transmit another DCI to UE 105 to schedule another PUSCH. In some embodiments of the present disclosure, the format of the DCs may be DCI format 0_0. In some other embodiments of the present disclosure, the format of the DCI may be DCI format 0_1. The specific definitions of the DCI formats are defined in the 3GPP specification TS 38.212. In the above example, UE 105 may need to transmit the PUSCH to TRP 103a according to the DCI, and transmit another PUSCH to TRP 103b according to the another DCI.

In wireless communication systems, such as 3GPP NR systems, a UE may be configured with uplink power control parameters (e.g., pathloss reference RSs) and beam indications (e.g., spatial relation information) for uplink transmissions (e.g., PUSCH or Physical Uplink Control Channel (PUCCH) transmissions). A UE may transmit a PUSCH scheduled by a DCI according to a pathloss reference RS (Reference Signal), spatial relation information, or the combination thereof.

As mentioned above with respect to FIG. 1, there is a scenario where multiple TRPs may schedule multiple PUSCHs by respective DCI. It would be beneficial if a PUSCH scheduled by a TRP (e.g., TRP 103a in FIG. 1) is transmitted to the same TRP (e.g., TRP 103a in FIG. 1), instead of a different TRP (e.g., TRP 103b in FIG. 1), especially when backhaul links between the TRPs are non-ideal. To achieve the above goal (i.e., a PUSCH scheduled by a TRP is transmitted to the same TRP), it would be advantageous if at least one of the following conditions is satisfied:
the pathloss reference RS s for the uplink power control of the PUSCHs scheduled by DCI from different TRPs are different; or
the spatial relation information for beam information indication of the PUSCHs scheduled by DCI from different TRPs is different.

Embodiments of the present disclosure provide solutions for transmitting a PUSCH scheduled by a DCI from a TRP. More details on the embodiments of the present disclosure will be illustrated in the following text in combination with the appended drawings.

As will be described below, embodiments of the present disclosure may employ a parameter which can distinguish TRPs to satisfy the above conditions. Persons skilled in the art would understand that other similar parameter may be employed to satisfy the above conditions without departing from the spirit and scope of the disclosure.

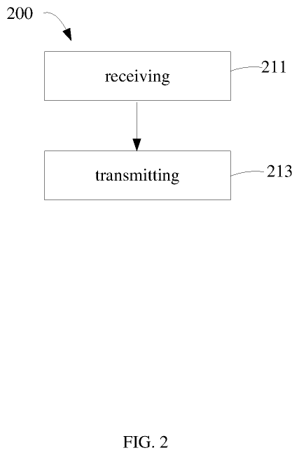

FIG. 2 illustrates a flow chart of an exemplary procedure 200 of uplink transmission according to some embodiments of the present disclosure. The procedure may be performed by a UE, for example, UE 105 in FIG. 1.

Referring to FIG. 2, in operation 211, a UE may receive a DCI in a CORESET. The DCI may be carried in a Physical Downlink Control Channel (PDCCH) in a search space associated with the CORESET. In some embodiments of the present disclosure, the format of the DCI may be DCI format 0_0. In some other embodiments of the present disclosure, the format of the DCI may be DCI format 0_1. In some embodiments of the present disclosure, the DCI may be from a TRP to schedule a PUSCH.

The UE may acquire configuration information regarding CORESETs from a higher layer (e.g., Radio Resource Control (RRC) layer) parameter, for example, the “PDCCH-Config” IE (Information Element). The formats for the “PDCCH-Config” IE are defined in the 3GPP specification TS 38.331. In some embodiments of the present disclosure, the configuration information regarding a CORESET may indicate a CORESET pool index. The CORESET pool index may be used to identify a TRP. In this way, since a DCI is received in a CORESET and a CORESET is configured with a CORESET pool index, the DCI is associated with the CORESET pool index of the CORESET in which the DCI is received.

For example, referring back to FIG. 1, UE 105 may be configured with CORESET #A and CORESET #B. CORESET #A may be configured with a CORESET pool index (e.g., CORESET pool index 0), and CORESET #B may be configured with another CORESET pool index (e.g., CORESET pool index 1). CORESET pool index 0 may be used to identify TRP 103a, and CORESET pool index 1 may be used to identify TRP 103b. UE 105 may receive a PDCCH (e.g., PDCCH #A) from TRP 103a in CORESET #A, and another PDCCH (e.g., PDCCH #B) from TRP 103b in CORESET #B. In this example, the DCI carried by PDCCH #A is associated with CORESET pool index 0, and the DCI carried by PDCCH #B is associated with CORESET pool index 1.

In some embodiments of the present disclosure, the CORESET pool index of a CORESET may be either “0” or “1.” In these embodiments, a base station may support only up to two TRPs.

In some other embodiments of the present disclosure, a CORESET may not be configured with a CORESET pool index. In these embodiments, the UE may assume that the CORESET is assigned with a default CORESET pool index (e.g., CORESET pool index 0).

Similarly, a Physical Uplink Control Channel (PUCCH) resource may be associated with a CORESET pool index. The specific definitions of the PUCCH Resource are defined in the 3GPP specification TS 38.213.

Referring to FIG. 2, in operation 213, the UE may transmit the PUSCH scheduled by the DCI according to a pathloss reference RS based on the CORESET pool index of the CORESET in which the DCI is received. In some embodiments of the present disclosure, the UE may transmit the PUSCH scheduled by the DCI according to spatial relation information based on the CORESET pool index of the CORESET in which the DCI is received.

In some embodiments of the present disclosure, the pathloss reference RS of a PUSCH scheduled by a DCI is in a list of PUSCH pathloss reference RSs identified by a predefined index. The predefined index may be associated with the CORESET pool index of the CORESET in which the DCI is received. In some embodiments of the present disclosure, different predefined indexes are associated with different CORESET pool indexes.

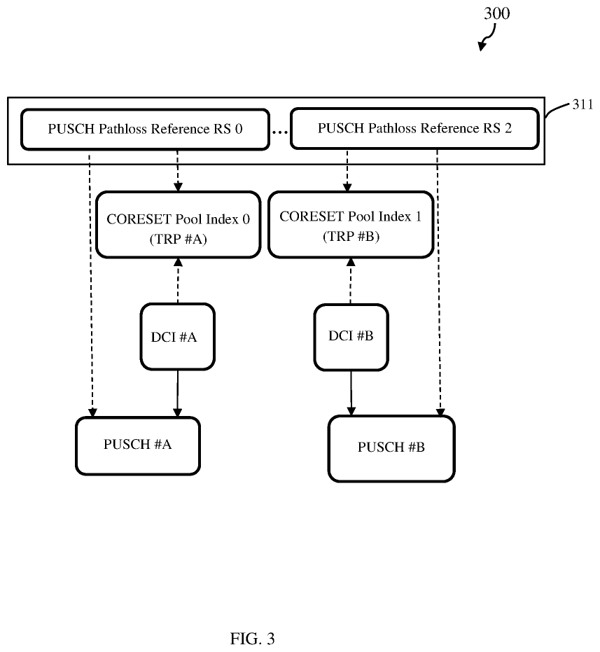

FIG. 3 shows in further detail an exemplary procedure 300 for determining pathloss reference RS of a PUSCH scheduled by a DCI according to the above embodiments.

Referring to FIG. 3, a UE may be configured with a list of PUSCH pathloss reference RSs, each of which may be identified by a respective index (e.g., PUSCH pathloss reference RS ID). The indexes of the PUSCH pathloss reference RSs may be configured by a higher layer, for example, a RRC layer. Referring to FIG. 3, a UE (e.g., UE 105 in FIG. 1) may be configured with a list of PUSCH pathloss reference RSs (e.g., list 311 in FIG. 3), including “PUSCH pathloss reference RS 0” to “PUSCH pathloss reference RS 2.” An index having a value of “0” may identify “PUSCH pathloss reference RS 0,” an index having a value of “1” may identify “PUSCH pathloss reference RS 1” (not shown in FIG. 3), and so on.

In some embodiments of the present disclosure, the pathloss reference RS of a PUSCH scheduled by a DCI is in the list of PUSCH pathloss reference RSs identified by a predefined index. The predefined index may be associated with the CORESET pool index of the CORESET in which the DCI is received. In some embodiments of the present disclosure, different predefined indexes are associated with different CORESET pool indexes. For example, at a UE or a base station, it may be predefined that a predefined index having the value of “0” is associated with a CORESET pool index (e.g., CORESET pool index 0), and another predefined index having the value of “2” is associated with another CORESET pool index (e.g., CORESET pool index 1).

Still referring to FIG. 3, a UE may receive a DCI (e.g., DCI #A) from a TRP (e.g., TRP #A) in CORESET #A, and another DCI (e.g., DCI #B) from another TRP (e.g., TRP #B) in CORESET #B. CORESET #A and CORESET #B may be configured with respective CORESET pool indexes, for example, CORESET pool index 0 and CORESET pool index 1, respectively. Therefore, DCI #A is associated with CORESET pool index 0 which identifies TRP #A, and DCI #B is associated with a CORESET pool index 1 which identifies TRP #B. The UE may then determine a pathloss reference RS of a PUSCH (e.g., PUSCH #A) scheduled by DCI #A based on CORESET pool index 0, and a pathloss reference RS of a PUSCH (e.g., PUSCH #B) scheduled by DCI #B based on CORESET pool index 1.

For example, for PUSCH #A, the UE may determine an RS resource index (corresponding to a pathloss reference RS) having a PUSCH pathloss reference RS ID being equal to the value of the predefined index associated with CORESET pool index 0. For PUSCH #B, the UE may determine an RS resource index (corresponding to a pathloss reference RS) having a PUSCH pathloss reference RS ID being equal to the value of the predefined index associated with CORESET pool index 1. In this exemplary procedure, at the UE, it is assumed that a predefined index having the value of “0” is associated with a CORESET pool index (e.g., CORESET pool index 0), and another predefined index having the value of “2” is associated with another CORESET pool index (e.g., CORESET pool index 1). Therefore, the UE may transmit PUSCH #A according to PUSCH pathloss reference RS 0, and may transmit PUSCH #B according to PUSCH pathloss reference RS 2.

It should be noted that, as the name suggests, a predefined index is predefined at the mobile terminal side apparatus (e.g., a UE), and the base station side apparatus (e.g., a BS or a TRP) may not need to transmit the predefined index to the UE. On the other hand, to ensure appropriate power control of uplink transmission, the base station should guarantee the correspondence between the PUSCH pathloss reference RS identified by the predefined index and the pool index, which is transparent to the UE.

Referring back to FIG. 2, in some embodiments of the present disclosure, the configuration information regarding a CORESET may indicate QCL assumptions such as Transmission Configuration Indicator (TCI) states. The TCI state may indicate a Quasi Co-Location (QCL) relationship between antenna ports used to transmit reference signals and antenna ports used to transmit data or control information to a UE. A quasi co-location (QCL) relationship between two antenna ports means that the properties of the channel over which a symbol on one antenna port is conveyed can be inferred from the channel over which a symbol on the other antenna port is conveyed. The radio channel properties which may be common across antenna ports may include Doppler shift, Doppler spread, average delay, delay spread, spatial Receive (RX) parameters, etc. These properties are also known as “large-scale channel properties” or “large-scale characteristic parameters.”

In some embodiments of the present disclosure, a TCI state in a CORESET may configure Quasi Co-Location (QCL) information of the antenna ports. The TCI state may include at least one instance of QCL information. A UE may decode downlink channels such as PDCCH or PDSCH using QCL information provided by TCI state(s). In some examples, a TCI state may include only one instance of QCL information, which may be referred to as the “first QCL information.” In some other examples, a TCI state may include two instances of QCL information. For example, the TCI state may first configure “first QCL information” and then configure “second QCL information.”

In some embodiments of the present disclosure, QCL information may indicate a reference signal (RS) and a QCL type corresponding to the RS. The QCL type may indicate which large-scale characteristic parameters are common across antenna ports. The specific definitions of the QLC types are defined in the 3GPP specification TS 38.214. For example, the QLC type may be QCL-TypeA, QCL-TypeB, QCL-TypeC, or QCL-TypeD. Table 1 below illustrates common large-scale characteristic parameters indicated by these QCL types:

TABLE 1

| QCLType | Large-Scale Characteristic Parameters |
|---|---|
| QCL-TypeA | Doppler shift, Doppler spread, |
| | average delay, delay spread |
| QCL-TypeB | Doppler shift, Doppler spread |
| QCL-TypeC | Doppler shift, average delay |
| QCL-TypeD | Spatial Rx parameter |

It should be noted that Table 1 is only an example to illustrate a correspondence between the QCL types and common large-scale characteristic parameters. In different application scenarios, the above QCL types may correspond to different large-scale characteristic parameters or different QCL types may be employed.

In some embodiments of the present disclosure, the TCI state may indicate a spatial QCL parameter. For example, the TCI state may include at least one QCL information which indicates QCL-TypeD.

In some embodiments of the present disclosure, the pathloss reference RS of a PUSCH scheduled by a DCI is an RS of Quasi Co-Location (QCL) information of a Transmission Configuration Indicator (TCI) state of a CORESET having the lowest index among all CORESETs configured with the same pool index as the CORESET in which the DCI is received when the TCI state of the CORESET does not indicate a spatial QCL parameter. In some embodiments of the present disclosure, the QCL information of the TCI state is the first QCL information in the TCI state.

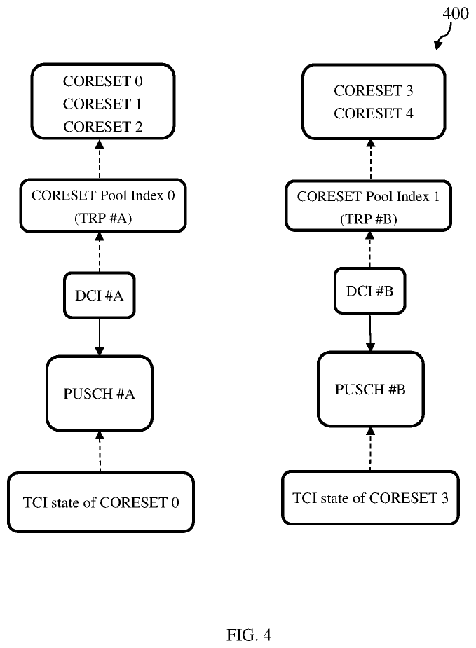

FIG. 4 shows in further detail an exemplary procedure 400 for determining pathloss reference RS of a PUSCH scheduled by a DCI according to the above embodiments.

Referring to FIG. 4, a UE (e.g., UE 105 in FIG. 1) may be configured with a plurality of CORESETs, which may be identified by respective indexes (e.g., CORESET IDs). For example, it is assumed that the UE is configured with CORESET 0, CORESET 1, CORESET 2, CORESET 3 and CORESET 4, wherein the numbers “0” to “4” are the indexes of these CORESETs. It is assumed that CORESET 0, CORESET 1 and CORESET 2 may be configured with the same CORESET pool index (e.g., CORESET Pool Index 0), and CORESET 3 and CORESET 4 may be configured with the same CORESET pool index (e.g., CORESET Pool Index 1). Therefore, the CORESET having the lowest index among all CORESETs configured with CORESET Pool Index 0 is CORESET 0, and the CORESET having the lowest index among all CORESETs configured with CORESET Pool Index 1 is CORESET 3.

In some embodiments of the present disclosure, procedure 400 may occur when the TCI state of the CORESET having the lowest index among all CORESETs configured with the same pool index does not indicate a spatial QCL parameter. For example, the TCI state of CORESET 0 does not indicate a spatial QCL parameter (e.g., QCL-TypeD), or the TCI state of CORESET 3 does not indicate a spatial QCL parameter (e.g., QCL-TypeD).

Still referring to FIG. 4, the UE may receive a DCI (e.g., DCI #A) from a TRP (e.g., TRP #A) in CORESET #A, and another DCI (e.g., DCI #B) from another TRP (e.g., TRP #B) in CORESET #B. CORESET #A and CORESET #B may be configured with respective CORESET pool indexes, for example, CORESET pool index 0 and CORESET pool index 1, respectively. CORESET #A may be one of CORESET 0, CORESET 1 and CORESET 2, and CORESET #B may be one of CORESET 3 and CORESET 4. The UE may then determine a pathloss reference RS of a PUSCH (e.g., PUSCH #A) scheduled by DCI #A based on CORESET pool index 0, and a pathloss reference RS of a PUSCH (e.g., PUSCH #B) scheduled by DCI #B based on CORESET pool index 1.

For example, for PUSCH #A, the UE may determine a reference signal of the QCL information of a TCI state of a CORESET having the lowest index among all CORESETs configured with CORESET pool index 0 (e.g., CORESET 0). For PUSCH #B, the UE may determine a reference signal of the QCL information of a TCI state of a CORESET having the lowest index among all CORESETs configured with CORESET pool index 1 (e.g., CORESET 3). In some embodiments, the QCL information of the TCI state is the first QCL information in the TCI state. Assuming that the RS of the first QCL information of the TCI state of CORESET 0 is RS 0, and the RS of the first QCL information of the TCI state of CORESET 3 is RS 4, the UE may transmit PUSCH #A according to the pathloss reference RS which is RS 0, and may transmit PUSCH #B according to the pathloss reference RS which is RS 4.

Referring back to FIG. 2, in some embodiments of the present disclosure, the pathloss reference RS of a PUSCH scheduled by a DCI may be associated with a spatial QCL parameter of a TCI state of a CORESET having the lowest index among all CORESETs configured with the same pool index as the CORESET in which the DCI is received. The spatial relation information of the PUSCH may be based on an RS, which may be associated with a spatial QCL parameter of a TCI state of a CORESET having the lowest index among all CORESETs configured with the same pool index as the CORESET in which the DCI is received.

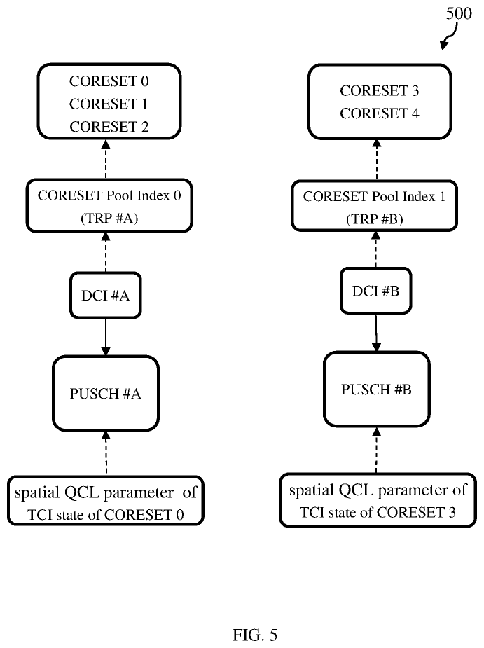

FIG. 5 shows in further detail an exemplary procedure 500 for determining pathloss reference RS and spatial relation information according to the above embodiments.

Referring to FIG. 5, a UE (e.g., UE 105 in FIG. 1) may be configured with a plurality of CORESETs, including, for example, CORESET 0, CORESET 1, CORESET 2, CORESET 3 and CORESET 4. It is assumed that CORESET 0, CORESET 1 and CORESET 2 may be configured with the same CORESET pool index (e.g., CORESET Pool Index 0), and CORESET 3 and CORESET 4 may be configured with the same CORESET pool index (e.g., CORESET Pool Index 1). Therefore, the CORESET having the lowest index among all CORESETs configured with CORESET Pool Index 0 is CORESET 0, and the CORESET having the lowest index among all CORESETs configured with CORESET Pool Index 1 is CORESET 3.

In some embodiments of the present disclosure, procedure 500 may occur when PUCCH resources are not configured or PUCCH resources are configured without spatial relation information. In some embodiments of the present disclosure, procedure 500 may occur when the TCI state of the CORESET having the lowest index among all CORESETs configured with the same pool index indicates a spatial QCL parameter. In some other embodiments of the present disclosure, procedure 500 may occur when PUCCH resources are configured with spatial relation information.

Still referring to FIG. 5, the UE may receive a DCI (e.g., DCI #A) from a TRP (e.g., TRP #A) in CORESET #A, and another DCI (e.g., DCI #B) from another TRP (e.g., TRP #B) in CORESET #B. CORESET #A and CORESET #B may be configured with respective CORESET pool indexes, for example, CORESET pool index 0 and CORESET pool index 1, respectively. CORESET #A may be one of CORESET 0, CORESET 1 and CORESET 2, and CORESET #B may be one of CORESET 3 and CORESET 4. The UE may then determine a pathloss reference RS of a PUSCH (e.g., PUSCH #A) scheduled by DCI #A based on CORESET pool index 0, and a pathloss reference RS of a PUSCH (e.g., PUSCH #B) scheduled by DCI #B based on CORESET pool index 1. The UE may also determine spatial relation information of PUSCH #A based on CORESET pool index 0, and spatial relation information of PUSCH #B based on CORESET pool index 1.

For example, for PUSCH #A, the UE may determine a reference signal associated with a spatial QCL parameter of a TCI state of a CORESET having the lowest index among all CORESETs configured with CORESET pool index 0 (e.g., CORESET 0). The UE may further determine the spatial relation information of PUSCH #A based on the determined reference signal of PUSCH #A.

Similarly, for PUSCH #B, the UE may determine a reference signal associated with a spatial QCL parameter of a TCI state of a CORESET having the lowest index among all CORESETs configured with CORESET pool index 1 (e.g., CORESET 3). The UE may further determine the spatial relation information of PUSCH #B based on the determined reference signal of PUSCH #B.

Assuming that the TCI state of CORESET 0 indicates a spatial QCL parameter (e.g., QCL-TypeD) and a reference signal 0 associated with the spatial QCL parameter, and the TCI state of CORESET 3 indicates a spatial QCL parameter (e.g., QCL-TypeD) and a reference signal 2 associated with the spatial QCL parameter, the UE may transmit PUSCH #A according to reference signal 0, and may transmit PUSCH #B according to reference signal 2. In some embodiments, the UE may further transmit PUSCH #A according to spatial relation information with reference to reference signal 0, and transmit PUSCH #B according to spatial relation information with reference to reference signal 2. In other words, the UE may determine uplink spatial relation by referring to a downlink RS.

Referring back to FIG. 2, in some embodiments of the present disclosure, the pathloss reference RS of a PUSCH scheduled by a DCI may be a pathloss reference RS of the Physical Uplink Control Channel (PUCCH) resource having the lowest resource index among all PUCCH resources associated with the pool index of the CORESET in which the DCI is received when at least one PUCCH resource is configured with spatial relation information. The spatial relation information may include spatial relation information of the PUCCH resource having the lowest resource index among all PUCCH resources associated with the pool index of the CORESET in which the DCI is received when at least one PUCCH resource is configured with spatial relation information.

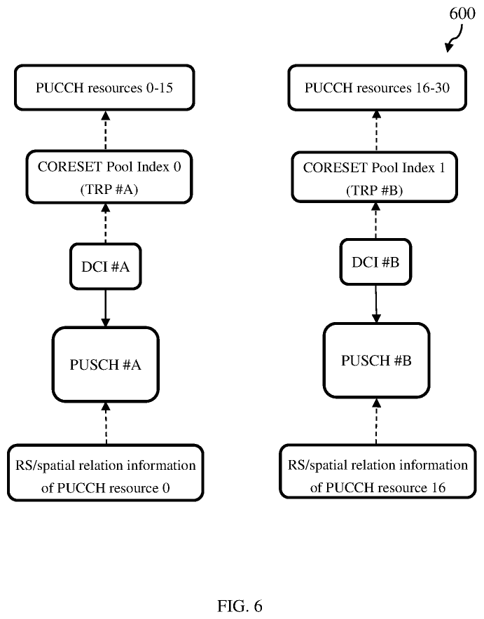

FIG. 6 shows in further detail an exemplary procedure 600 for determining pathloss reference RS and spatial relation information according to the above embodiments. In some embodiments of the present disclosure, procedure 600 may occur when PUCCH resources are configured with spatial relation information.

Referring to FIG. 6, the UE may receive a DCI (e.g., DCI #A) from a TRP (e.g., TRP #A) in CORESET #A, and another DCI (e.g., DCI #B) from another TRP (e.g., TRP #B) in CORESET #B. CORESET #A and CORESET #B may be configured with respective CORESET pool indexes, for example, CORESET pool index 0 and CORESET pool index 1, respectively. PUCCH resources 0 to 15 may be associated with CORESET Pool Index 0, and PUCCH resources 16 to 31 may be associated with CORESET Pool Index 1. Therefore, the PUCCH resource having the lowest index among all PUCCH resources associated with CORESET Pool Index 0 is PUCCH resource 0, and the PUCCH resource having the lowest index among all PUCCH resources associated with CORESET Pool Index 1 is PUCCH resource 16.

The UE may then determine a pathloss reference RS of a PUSCH (e.g., PUSCH #A) scheduled by DCI #A based on CORESET pool index 0, and a pathloss reference RS of a PUSCH (e.g., PUSCH #B) scheduled by DCI #B based on CORESET pool index 1. The UE may also determine spatial relation information of PUSCH #A based on CORESET pool index 0, and spatial relation information of PUSCH #B based on CORESET pool index 1.

For example, for PUSCH #A, the UE may determine the pathloss reference RS of PUSCH #A being the pathloss reference RS of the PUCCH resource having the lowest resource index among all PUCCH resources associated with CORESET pool index 0 (e.g., PUCCH resource 0). The UE may further determine the spatial relation information of PUSCH #A being the spatial relation information of PUCCH resource 0.

Similarly, for PUSCH #B, the UE may determine the pathloss reference RS of PUSCH #A being the pathloss reference RS of the PUCCH resource having the lowest resource index among all PUCCH resources associated with CORESET pool index 1 (e.g., PUCCH resource 16). The UE may further determine the spatial relation information of PUSCH #B being the spatial relation information of PUCCH resource 16.

Referring back to FIG. 2, in some embodiments of the present disclosure, the CORESET pool index may not be configured. In these embodiments, the spatial relation information of a PUSCH scheduled by a DCI may be associated with a dedicated PUCCH resource. For example, a UE may transmit a PUSCH according to the spatial relation information of the PUCCH resource having the lowest resource index within the active uplink BWP (BandWidth Part). The specific definitions of the PUCCH Resource are defined in the 3GPP specification TS 38.213. In some examples, the UE may determine a pathloss reference RS for a PUSCH scheduled by a DCI according to a procedure drafted in the 3GPP specification TS 38.213.

As is well-known, two types of Frequency Ranges (FRs) are defined in 3GPP 5G (NR). One is the sub 6 GHZ range (hereinafter referred to as “FR1”), and the other is the millimeter wave range (hereinafter referred to as “FR2”). In some embodiments of the present disclosure, the operating frequency of a communication system may be in the FR1. In these embodiments, beam indications (e.g., spatial relation information) may be not required during PUSCH transmission. For example, a UE may transmit a PUSCH scheduled by a DCI according to a pathloss reference RS. The UE does not need to determine the spatial relation information for the PUSCH transmission. The UE may determine the pathloss reference RS of the PUSCH based on the methods described above with respect to FIGS. 2-6.

In some embodiments of the present disclosure, the operating frequency of a communication system may be in the FR2. In these embodiments, both pathloss reference RSs and beam indications are required during PUSCH transmission. For example, a UE may transmit a PUSCH scheduled by a DCI according to both a pathloss reference RS and a spatial relation information for the PUSCH transmission. The UE may determine the pathloss reference RS and the spatial relation information of the PUSCH based on the methods described above with respect to FIGS. 2, 5, and 6.

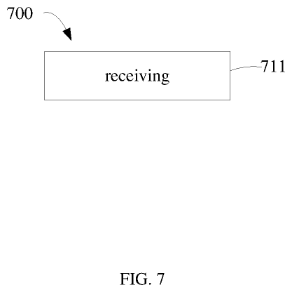

FIG. 7 illustrates a flow chart of an exemplary procedure 700 of uplink reception according to some embodiments of the present disclosure. The procedure may be performed by a base station side apparatus. The base station side apparatus may be base station 101, TRP 103a, or TRP 103b as shown in FIG. 1 or any combination of them. That is, from the UE's perspective, the based station 101, TRP 103a, and TRP 103b can be deemed as one apparatus, although they are distinguished here for the convenience of description.

Referring to FIG. 7, in operation 711, a base station side apparatus may receive a PUSCH scheduled by a DCI from a UE. The DCI may be carried in a PDCCH in a search space associated with a CORESET. In some embodiments of the present disclosure, the format of the DCI may be DCI format 0_0. In some other embodiments of the present disclosure, the format of the DCI may be DCI format 0_1.

In some embodiments of the present disclosure, the pathloss reference RS of the PUSCH may be based on the CORESET pool index of the CORESET for the DCI. In some embodiments of the present disclosure, the spatial relation information of the PUSCH may be based on the CORESET pool index of the CORESET for the DCI. The pathloss reference RS and the spatial relation information may be determined according to one of the methods described above with respect to FIGS. 2-6.

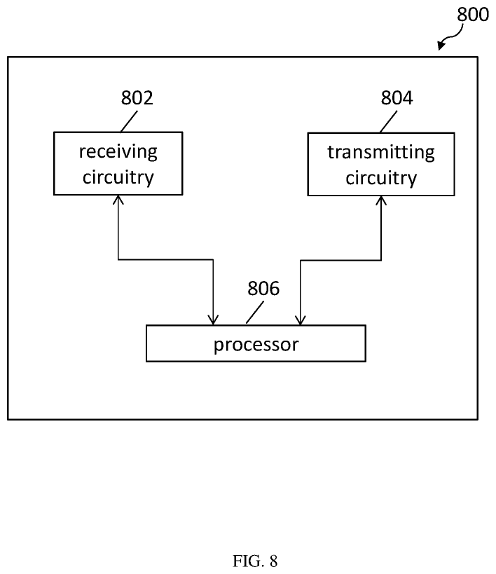

FIG. 8 illustrates an example block diagram of an apparatus 800 according to some embodiments of the present disclosure.

As shown in FIG. 8, the apparatus 800 may include at least one non-transitory computer-readable medium (not illustrated in FIG. 8), a receiving circuitry 802, a transmitting circuitry 804, and a processor 806 coupled to the non-transitory computer-readable medium (not illustrated in FIG. 8), the receiving circuitry 802 and the transmitting circuitry 804. The apparatus 800 may be a base station side apparatus (e.g., a BS or a TRP) or a communication device (e.g., a UE).

Although in this figure, elements such as processor 806, transmitting circuitry 804, and receiving circuitry 802 are described in the singular, the plural is contemplated unless a limitation to the singular is explicitly stated. In some embodiments of the present disclosure, the receiving circuitry 802 and the transmitting circuitry 804 are combined into a single device, such as a transceiver. In certain embodiments of the present disclosure, the apparatus 800 may further include an input device, a memory, and/or other components.

In some embodiments of the present disclosure, the non-transitory computer-readable medium may have stored thereon computer-executable instructions to cause a processor to implement the method with respect to the UE as described above. For example, the computer-executable instructions, when executed, cause the processor 806 interacting with receiving circuitry 802 and transmitting circuitry 804, so as to perform the steps with respect to the UE depicted in FIGS. 1 and 2-6.

In some embodiments of the present disclosure, the non-transitory computer-readable medium may have stored thereon computer-executable instructions to cause a processor to implement the method with respect to the BS or TRP as described above. For example, the computer-executable instructions, when executed, cause the processor 806 interacting with receiving circuitry 802 and transmitting circuitry 804, so as to perform the steps with respect to the BS or TRP depicted in FIGS. 1 and 7.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method, comprising:
receiving Downlink Control Information (DCI) in a first Control Resource Set (CORESET), wherein the DCI schedules a Physical Uplink Shared Channel (PUSCH) and the first CORESET is configured with a first pool index; and
transmitting the PUSCH scheduled by the DCI according to a pathloss reference Reference Signal (RS) based on the first pool index.

2. The method of claim 1, wherein a format of the DCI is DCI format 0_0.

3. The method of claim 1, wherein transmitting the PUSCH scheduled by the DCI further comprises:
transmitting the PUSCH scheduled by the DCI according to spatial relation information based on the first pool index.

4. The method of claim 1, wherein the pathloss reference RS of the PUSCH is in a list of PUSCH pathloss reference RS s identified by a predefined index, and the predefined index is associated with the first pool index.

5. (canceled)

6. (Canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. An apparatus, comprising:
at least one receiver that receives Downlink Control Information (DCI) in a first Control Resource Set (CORESET), wherein the DCI schedules a Physical Uplink Shared Channel (PUSCH) and the first CORESET is configured with a first pool index; and
at least one transmitter that transmits the PUSCH scheduled by the DCI according to a pathloss reference Reference Signal (RS) based on the first pool index.

24. The apparatus of claim 23, wherein a format of the DCI is DCI format 0_0.

25. The apparatus of claim 23, wherein the at least one transmitter transmits the PUSCH scheduled by the DCI further according to spatial relation information based on the first pool index.

26. The apparatus of claim 23, wherein the pathloss reference RS of the PUSCH is in a list of PUSCH pathloss reference RS s identified by a predefined index, wherein the predefined index is associated with the first pool index.

27. The apparatus of claim 26, wherein different predefined indexes are associated with different pool indexes.

28. The apparatus of claim 23, wherein the pathloss reference RS of the PUSCH is an RS of Quasi Co-Location (QCL) information of a Transmission Configuration Indicator (TCI) state of a second CORESET having a lowest index among all CORESETs configured with the first pool index when the TCI state of the second CORESET does not indicate a spatial QCL parameter.

29. The apparatus of claim 28, wherein the QCL information of the TCI state is first QCL information in the TCI state.

30. The apparatus of claim 23, wherein the pathloss reference RS of the PUSCH is associated with a spatial Quasi Co-Location (QCL) parameter of a Transmission Configuration Indicator (TCI) state of a second CORESET having a lowest index among all CORESETs configured with the first pool index.

31. The apparatus of claim 23, wherein the pathloss reference RS of the PUSCH is a pathloss reference RS of a Physical Uplink Control Channel (PUCCH) resource having a lowest resource index among all PUCCH resources associated with the first pool index when at least one PUCCH resource is configured with spatial relation information.

32. The apparatus of claim 25, wherein the spatial relation information is based on an RS, and the RS is associated with a spatial Quasi Co-Location (QCL) parameter of a Transmission Configuration Indicator (TCI) state of a second CORESET having a lowest index among all CORESETs configured with the first pool index.

33. The apparatus of claim 25, wherein the spatial relation information comprises spatial relation information of a Physical Uplink Control Channel (PUCCH) resource having a lowest resource index among all PUCCH resources associated with the first pool index when at least one PUCCH resource is configured with spatial relation information.

34. An apparatus, comprising:
at least one receiver that receives a Physical Uplink Shared Channel (PUSCH) scheduled by Downlink Control Information (DCI), and
wherein a pathloss reference Reference Signal (RS) of the PUSCH is based on a first pool index configured in a first Control Resource Set (CORESET) for the DCI.

35. (canceled)

36. (canceled)

37. (canceled)

38. (canceled)

39. The apparatus of claim 34, wherein the pathloss reference RS of the PUSCH is an RS of Quasi Co-Location (QCL) information of a Transmission Configuration Indicator (TCI) state of a second CORESET having a lowest index among all CORESETs configured with the first pool index when the TCI state of the second CORESET does not indicate a spatial QCL parameter.

40. The apparatus of claim 39, wherein the QCL information of the TCI state is first QCL information in the TCI state.

41. The apparatus of claim 34, wherein the pathloss reference RS of the PUSCH is associated with a spatial Quasi Co-Location (QCL) parameter of a Transmission Configuration Indicator (TCI) state of a second CORESET having a lowest index among all CORESETs configured with the first pool index.

42. The apparatus of claim 34, wherein the pathloss reference RS of the PUSCH is a pathloss reference RS of a Physical Uplink Control Channel (PUCCH) resource having a lowest resource index among all PUCCH resources associated with the first pool index when at least one PUCCH resource is configured with spatial relation information.

43. (canceled)

44. (canceled)
